(19) United States
(12) Patent Application Publication
(10) Pub. No.: US 2008/0162186 A1
(43) Pub. Date: Jul. 3, 2008

(54) System and method for diet and exercise

(76) Inventor: Michael Jones, North Las Vegas, NV (US)

Correspondence Address: JAMES RAY & ASSOCIATES, 2640 PITCAIRN ROAD, MONROEVILLE, PA, 15146, US

(21) Appl. No.: 12/005,973

(22) Filed: Dec. 28, 2007

Related U.S. Application Data
(60) Provisional application No. 60/882,344, filed on Dec. 28, 2006.

(51) Int. Cl. G06Q 50/00

(52) U.S. Cl. 705/2

(57) ABSTRACT

A method for generating and implementing personalized exercise and diet regimens includes initial steps of inputting into an electronic device with a graphical user interface personal data, exercise and diet goals, and a database of food items and related nutritional information; subsequently generating exercise and diet programs correlated to the personal data and goals. Implementing the personalized exercise regimen includes inputting the most recently completed exercise course, outputting a recommended next exercise course correlated with the most recently completed exercise course and the personalized exercise regimen, and performing the exercises. Implementing the diet regimen includes selecting at least one food item which is about to be purchased or consumed, and inputting data identifying the food item and nutritional values. These data are correlated with the recommended diet program; and output is displayed providing recommendations regarding purchase of that food item and suitable alternatives.

### CROSS REFERENCE TO RELATED APPLICATION

This patent application is related to and claims priority from U.S. Provisional Patent Application Ser. No. 60/882,344 filed Dec. 28, 2006.

### FIELD OF THE INVENTION

The present invention relates, in general, to monitoring exercise and diet and, more particularly, this invention relates to electronic aids for creating and conducting personally customized diet and exercise regimens.

### BACKGROUND OF THE INVENTION

Prior to the conception and development of the present invention, people often dieted and exercised in accordance with general recommendations. While it is commonly recommended that a doctor be consulted before beginning exercise and diet programs, this advice is not always heeded, and it would not be practical to have frequent follow-up with a doctor.

Blum, et al, in U.S. Pat. No. 4,686,624 discloses a portable apparatus for acquiring and processing data pertaining to an individual's diet and health. It can interface with a computer, but is not designed for easy input of data at a point of purchase of food. U.S. Pat. No. 5,412,564 to Ecer teaches a system and method for diet control based on a central computer. A user's information is put in via a “smart card” and bar-code data is entered at a point of purchase.

In U.S. Pat. No. 5,478,989, Shepley discloses a personalized nutrition information system that provides individualized feedback to the user on specific purchases the user is about to make. It could quickly draw the user's attention, prior to purchasing, to items that may be detrimental to his or her diet objectives.

Mansfield et al in U.S. Pat. No. 5,819,735 disclose a portable autonomous electronic device that incorporates a nutrition facts database, ways to update it, and a means to rapidly input nutritional information about foods prior to purchase or consumption. It also stores and displays daily and weekly totals of nutritional information for the user. Neither Mansfield nor any of the other three prior-art patents referenced above take into account or monitor the person's exercise program.

U.S. Pat. Application Publication 2005/0121504 discloses a system for monitoring fitness and diet programs on a portable handheld device. U.S. Pat. Application Publication 2005/0182302 discloses a system and apparatus for evaluating the health and wellness of an individual. The emphasis in 2005/0182302 appears to be on utilizing a cell phone to do this. None of the aforementioned patents or applications discloses feeding back to the user alternative food purchase recommendations at the point of purchase based on nutritional data.

### SUMMARY OF THE INVENTION

The present invention provides a method for generating and implementing personalized exercise and diet regimens that includes initial steps of 1) inputting personal data relating to an individual user into an electronic device with a graphical user interface; 2) inputting a customized exercise and diet goals into this device; 3) generating within the electronic device a diet program correlated to the personal data and diet goals; and, 4) inputting to the electronic device a database of food items and related nutritional information such that food items and related nutritional information can be correlated to electronic inputs. The personalized exercise regimen includes steps of inputting a list of the most recently completed exercise course, outputting to an individual user a recommended next exercise course correlated with the most recently completed exercise course and the personalized exercise regimen, and performing the exercises. Implementing the diet regimen includes selecting at least one food item which is about to be purchased or consumed, and inputting data identifying the food item and nutritional values. These data are correlated with the recommended diet program; and output is displayed providing recommendations regarding purchase of this food item and suitable alternatives.

In preferred embodiments, the food item data are input via a bar code reader or a mobile-phone camera. In an alternative embodiment, the computer software and memory reside remotely at a secure website.

### OBJECTS OF THE INVENTION

It is, therefore, one of the primary objects of the present invention to provide a conveniently-accessible computer software and memory that stores health-related information specific to the user and can rapidly provide the user feedback on food purchases about to be made.

Another object of the present invention is to provide a system and method for monitoring both the diet and exercise program of an individual, including those in special populations with known health problems.

Still another object of the present invention is to provide a portable device storing personal information regarding the user's health and making customized recommendations for healthier purchases prior to purchasing or consuming.

Yet another object of the present invention is to provide a user with a convenient electronic log of exercise and diet regimens.

An additional object of the present invention is to aid users in regularly adhering to medical advice in the area of diet and exercise based on their particular health profile.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a block diagram of the diet and exercise information system.

FIG. 2 is a flowchart depicting the interaction of the user with the apparatus and software.

FIG. 3 is a chart summarizing the typical user input.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

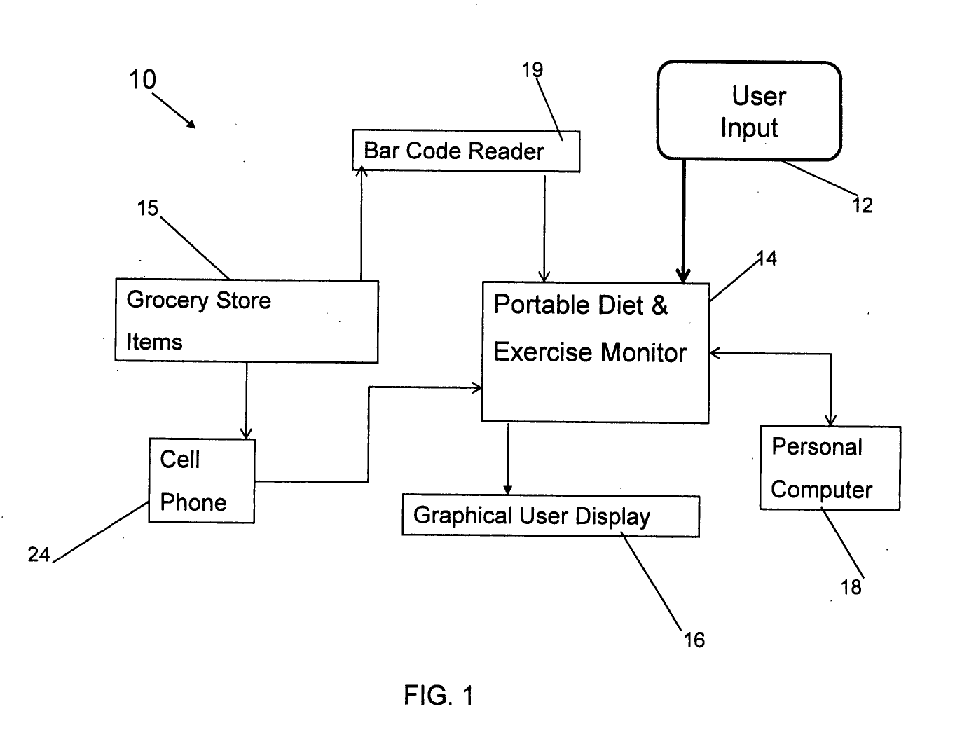

Referring initially to FIG. 1, a block flow diagram is provided to show the overall interaction of a user with the diet and exercise system 10. A portable electronic device 14 receives and stores input 12 from a user. This includes a wide array of health, medical, and personal information such as height, weight, allergies, cholesterol values, diet and exercise objectives, as well as chronic conditions like diabetes. This information can be input via menus, a computer download, or keyed entry. The electronic device 12 sorts the information and stores it by category. The user input 12 plus any output for the user are presented by way of a graphical user display or interface 16, which may include sound, and could be all in one housing. The electronic device 14 may be a custom built unit or a commercially available multi-purpose device such as a personal digital assistant (PDA), multi-media device, laptop computer or even a “smart” cell phone. One of the primary purposes of the device 14 is to assist with wise food purchases, typically grocery store items 15. A food and nutrition data base would be built up and updated if necessary in the portable monitor 14. Assistance with building a UPC barcode database can be found at www.upcdatabase.com. The entry of data could be done with the graphical user interface, or using a personal computer 18, or even the Internet. Identifying information for a candidate purchase can be input via a bar-code reader 19 or even a cell phone 24 with a built-in camera. The software built into the portable monitor 14 then locates the nutritional data in the data base for that item, and compares it to similar items in the same category. Recommendations are then transmitted to the graphical user display 16 for the user to act on. If the nutritional data are not already in the portable device 14, the user can input it from the label of the item 15 using the graphical user interface 16. Exercise information and progress will also be part of the user input 12. The software within the portable device will categorize and properly store all the input information. It should be obvious that the scope of the system 10 could be scaled down to either exercise only, or diet and food only, but these are less-preferred alternatives.

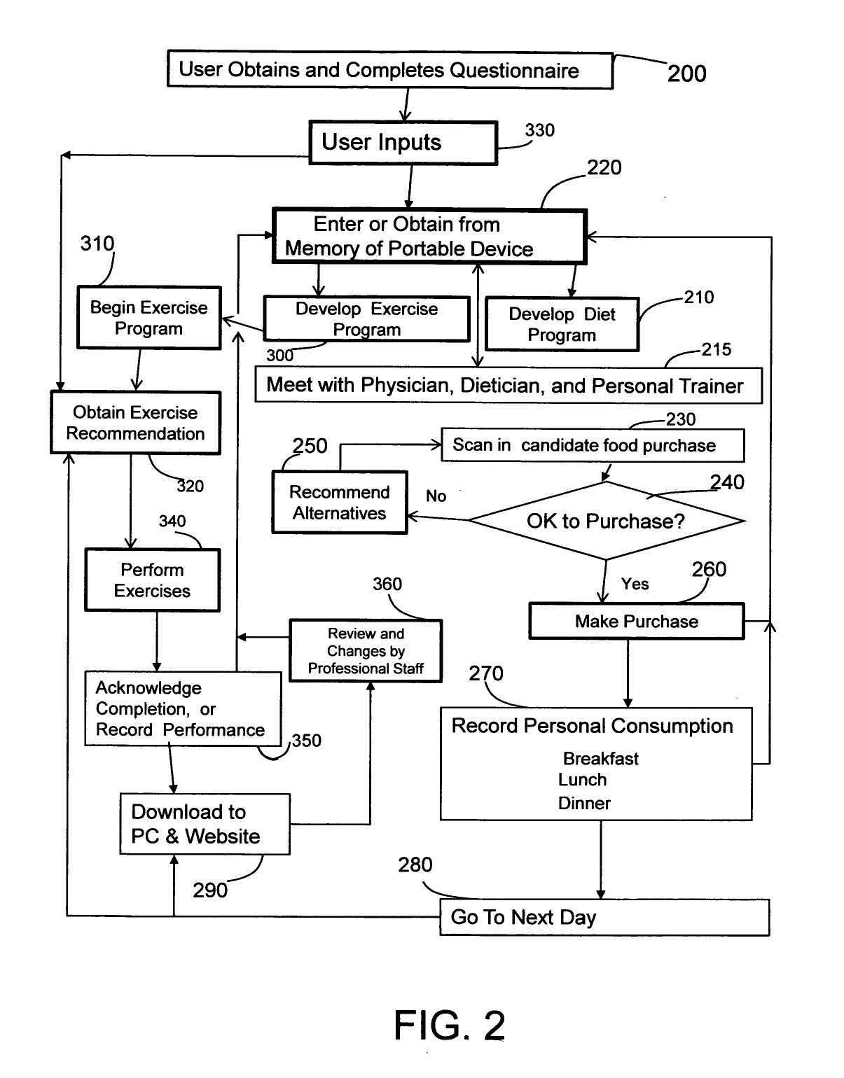

FIG. 2. is a simplified flow diagram of how the system of hardware and software would be utilized. Very important early input entries begin with a user obtaining and completing a questionnaire 200. The questionnaire answers plus any additional user input 330 are entered into the memory of a device 220 via any of various options including download from a computer or entry from a graphical user interface. The software has been enabled by special algorithms to generate a diet program 210, and an exercise program 300. The software in the portable device 220 could also generate recommendations and warnings. It has been custom programmed to deal not only with normal healthy adults, but also those having significant health issues such as diabetes and heart problems. These programs and any limitations can then be reviewed as deemed necessary with a doctor, dietician, and personal trainer, step 215. The software even provides the user with a customized list of appropriate questions to ask each. An alternative location for this software to reside could be a secure web site, but for simplicity, only the portable device option is described herein.

When the user begins the exercise program at 310, an exercise recommendation 320 is obtained from the memory of the portable device 220. The user then performs the exercise routine 340, and afterwards, at step 350, acknowledges completion or records details of actual performance into the memory of the portable device 220, and optionally into a personal computer PC or website 290. When the user wishes to purchase or consume food, they scan in identifying information for the intended purchase 230, most typically with a barcode scanner or cell phone imaging device. The portable device 220 processes and evaluates the nutritional data and makes a recommendation 240 regarding the intended purchase based on the diet program 210. The output will be either an approval to purchase 260, or recommended alternatives 250, or both. Through the course of the day, the user records all personal food and drink consumption 270. In addition, the information can be downloaded to a personal computer or website 290. On the next day 280, the user may start by reviewing the exercise recommendation 320, if exercise is scheduled for that day. The exercise recommendation 320 would typically be a sequence of elements with repetitions and pacing. There may also be capability to check off items as completed. Food purchases would be evaluated for this subsequent day as needed. Also, there would be occasional reviews and alterations to the programs by the professional staff as indicated by step 360. This would typically be done by access through a secure website 290.

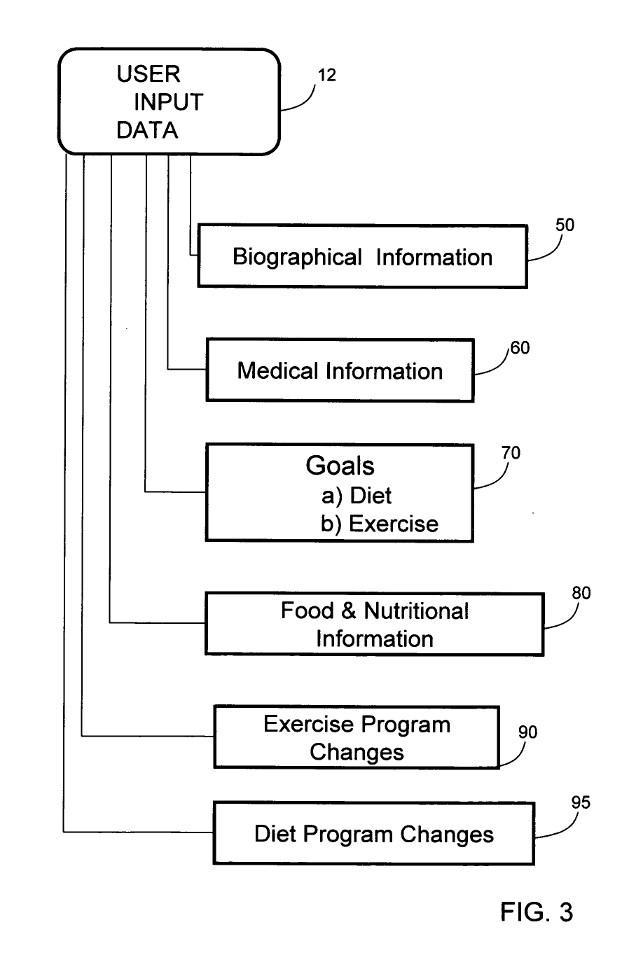

FIG. 3 lists much of the user personal input data 12. First would be biographical information 50 such as name, address, date of birth, gender, ethnicity, email address, and phone numbers. Next would be a host of medical information 60, including, but not limited to, allergies, recent blood pressures and resting pulse rates, cholesterol values, operations, medicines being taken, activity restrictions, diabetic conditions, and miscellaneous comments. Another input category would be goals 70, both diet and exercise related. These would likely be developed by the computer software with subsequent review by a doctor, personal trainer, and dietician, in any combination. The user could also manually input food information 80, related either to purchases or consumption. Much of this would be to build up a data base for future reference, typically by bar code input. Details of the exercise program 90 would be modified by the doctor or personal trainer as deemed necessary. In addition, details of the diet program 95 would be altered as warranted by the dietician or doctor. All of the above information might also be input via the Internet to a commercial website or emailed data files.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. A method for generating and implementing personalized exercise and diet regimens comprising the steps of:
a) inputting personal data related to an individual user into an electronic device with a graphical user interface;
b) inputting personalized exercise goals and diet goals into said electronic device;
c) generating within said electronic device diet and exercise programs correlated to said personal data and said diet and exercise goals;
d) inputting to said electronic device a database of food items and related nutritional information wherein said food item data and related nutritional information are transferred by a predetermined electronic transfer means;
e) inputting to said electronic device a list of most recently completed exercise course;
f) outputting to said individual user a recommended next exercise course correlated with said most recently completed exercise course and said personalized exercise regimen;
g) selecting at least one food item which said individual user intends to one of purchase and consume and inputting data identifying said food item;
h) correlating said data identifying said food item with said nutritional information and said recommended diet program; and,
i) outputting to said individual user recommendations regarding purchase of said at least one food item and recommendations of suitable alternatives.

2. The method for generating and implementing diet and exercise regimens, according to claim 1, wherein said method includes an additional step of using an Internet connection for assisting in transmitting said personal data, said nutritional information, said exercise course, and said recommended next exercise course.

3. A method for electronic recording and monitoring of diet and nutritional information wherein said information is customized to a specific user, said method comprising:
providing computer means with memory for storing nutritional and product identification information on foods and drinks commonly available and enabling said computer means to process said nutritional information and said product identification information;
entering to said computer means user-specific information on health and medical conditions, and health-related objectives, and enabling said computer means to categorize and process said health and medical information;
enabling said computer means to generate a diet program customized to said specific user;
providing means for transmitting product identification and nutritional information of said foods and drinks when being purchased at one of a store and restaurant location to a graphical user interface communicating with said computer means;
assigning via computer means a category for potential food and drink purchases;
providing real time clock means connected to said computer means for maintaining current date record and for determining duration of said recording and monitoring activity for the purpose of creating daily averages of nutritional consumption by said specific user;
inputting to computer means said current nutritional consumption data including nutritional contents of said foods and drinks purchased in latest purchase transaction, and said historical nutritional consumption data including averages of daily nutrition consumption by said specific user averaged over selected periods of time;
assessing merits of said potential food purchase against preselected personal criteria and making recommendation regarding purchase;
recommending alternative food purchase in same said category for said potential food purchases identified as exceeding said preselected criteria;
transmitting product identification information on said foods and drinks being purchased by said specific user to said computer means;
maintaining a current date record and determining duration of said recording and monitoring activity by a real time clock, said computer means creating a list of totals of said nutrition in said foods and drinks purchased;
operating said computer means to create new daily averages of nutrition consumption by said consumer by using historical daily nutrition consumption data stored in said memory, totals of said nutrition from last purchase stored in said memory; and
said computer means writing into said memory new daily averages of nutrition consumption by said specific user and current list of said totals of said nutrition in said foods and drinks consumed.

4. The method for electronic recording and monitoring of diet and nutritional information, according to claim 3, wherein said method includes an additional step of using a uniform bar code system for assisting in transmitting said product identification information.

5. The method for electronic recording and monitoring of diet and nutritional information, according to claim 3, wherein said method includes an additional step of using a mobile phone imaging unit for assisting in transmitting said product identification information.

6. A method for generating and monitoring personalized exercise regimens comprising the steps of:
a) inputting personal data relating to an individual user into an electronic device with a graphical user interface;
b) inputting exercise goals into said electronic device;
c) enabling computer software in said electronic device to generate an exercise program and initial exercise course customized to said individual user;
d) inputting to said electronic device a list of most recently completed exercise course;
e) generating a recommended next exercise course correlated with said most recently completed exercise course and said personalized exercise regimen; and
f) outputting to said individual user a recommended next exercise course.
